(19) United States
(12) Patent Application Publication
(10) Pub. No.: US 2004/0108162 A1
(43) Pub. Date: Jun. 10, 2004

(54) Sound level adjustable muffler

(76) Inventor: Gilles Couvrette, Laval (CA)

Correspondence Address: INVENTARIUM, Suite 1607, 4050 Rosemont Blvd, Montreal, QC, H1X 1MR, CA

(21) Appl. No.: 10/723,816

(22) Filed: Nov. 26, 2003

Related U.S. Application Data
(60) Provisional application No. 60/430,122, filed on Dec. 2, 2002.

(51) Int. Cl. F01N 1/16; F01N 7/18; F02K 1/08

(52) U.S. Cl. 181/241; 181/219; 181/277

(57) ABSTRACT

A sound level adjustable muffler has a pop-up mechanism working in parallel pairs used for lifting the tabletop part of a piece of furniture has a pair of cantilever arms joined together by an upper oblong member and a lower oblong member, both said upper oblong member and lower oblong member being parallel relative to each other and each being rotationally attached to opposite ends of said pair of cantilever arms.

This application claims priority based on provisional application No. 60/430,122 filed on Dec. 2, 2002

### BACKGROUND OF THE INVENTION

1. Field of the invention

This invention relates generally to vehicle mufflers in general but more particularly to a motorcycle muffler having sound level adjusting properties.

2. Background

The use of mufflers on vehicles equipped with internal combustion engines has been known for years. Over the years, muffler development has focused into two main areas: Engine power output enhancement and sound reduction. Although the prior art shows several improvements aimed at adjustments for varying engine performance, few are involved in variable sound output. Those that have such a characteristic have gained it more as a side effect of the performance adjustment means than as the primary intended effect. New sound level regulations in neighborhoods of some cities regulate the amount of noise a vehicle can emit. Although this is of little concern to normal motor vehicles, motorcycles are more affected with those regulations. Since motorcycle riders often like to hear the sound of their vehicle as they cruise down a road, a practical way of reducing the sound level when riding in some areas while allowing the motorcycle to generate more sound in unregulated areas would be a bonus for riders.

There is therefore a need for a practical and easy to use sound level adjustable muffler.

### SUMMARY OF THE INVENTION

It is a first object of the present invention is to provide a muffler having a sound level adjustment.

It is a second object of the invention is to provide a muffler with a sound level adjustment that can be done while the motorcycle's engine is operating.

It is a final object of the invention to provide a muffler with a sound level adjustment that can be done while the motorcycle is riding.

In order to do so, the ratio between the surface area of the opening for the intake of exhaust gases from the exhaust pipe at the entrance to the muffler varies from being at least equal to the surface area available for the exhaust right at the exit of the muffler to being larger than the surface area available for the exhaust right at the exit of the muffler. The larger the surface area available at the exit of the muffler, the louder the sound that escapes. A movable plug that slides along the longitudinal axis of the muffler varies the available surface area.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

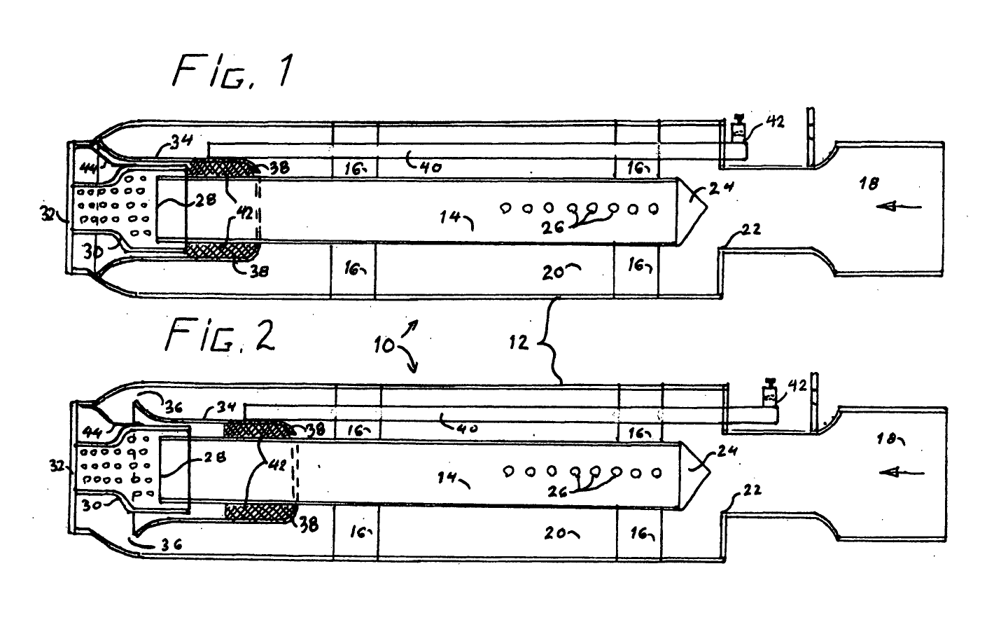

FIG. 1 Cut out side view of the sound level adjustable muffler in the low sound mode. FIG. 2 Cut out side view of the sound level adjustable muffler in the loud sound mode.

### DETAILED DESCRIPTION OF THE PREFERRED EMBODIMENT

A sound level adjustable muffler (10) has an outer cylinder (12) and an inner resonator (14) which is held in place at the center of the outer cylinder (12) by way of supporting segments (16). Exhaust coming in through an exhaust pipe (18) by way of an entrance port (22)enters a muffler chamber (20) which is defined as the space within the outer cylinder(12) and outside the inner resonator (14). The entrance port (22) has a given surface area at its opening. In FIG. 1, the exhaust is diverted by a resonator cone (24), travels through the muffler chamber (20), and enters the inner resonator (14) by way of a series of resonator holes (26) made along the length of the inner resonator (14). Once inside the inner resonator (14), the exhaust travels towards an open resonator end (28), passes through a secondary resonator (30), and exits by an exit port (32). The total surface area available at the secondary resonator is equal to the available surface area at the entrance port when a moveable plug (34) is closed such as in FIG. 1.

When the moveable plug (34) is opened, as in FIG. 2, the exhaust that travels through the muffler chamber (20), besides going through the inner resonator (14) as before, passes through an annular passage (36) which surrounds the periphery of the moveable plug (34), thus increasing the surface area available for the exhaust. Because of the annular passage (36), a secondary resonator support segment (44) is needed to support an otherwise floating secondary resonator (30). The moveable plug (34) is actuated by a sliding rod (40) which slides along an axis parallel to the length of the outer cylinder (12) and can have a horn like ending, depending upon the shape of the outer cylinder (12). A cylindrical seal (38) seals the area between the outside of the inner resonator (14) and the inside of the moveable plug (34). The sliding rod (40) is itself activated by any one of several available means such as a direct connection to an actuating motor (not shown) or indirect connection by way of a cable which could be adjusted by a control lever near handlebars or else an electric motor having an electrical control near the handlebars (not shown) or any convenient location so that a user can actually adjust the sound level while driving the motorcycle. Whatever the means used, an attachment means (42) is provided at the end of the sliding rod (40) for that purpose. Since the surface area can increase by a factor of 4 to 5 according to how much the movealble plug (34) is opened, the sound level more or less follows the same order of magnitude.

1. A sound level adjustable muffler to vary the sound level at the exhaust comprising:
an outer cylinder and an inner resonator;
a muffler chamber being defined as the space within said outer cylinder and the outside of said inner resonator;
an entrance port having a given opening area and through which said exhaust gases enter said muffler chamber;
a resonator cone to divert exhaust gases around said inner resonator;
said inner resonator having a plurality of resonator holes along its length and through which enters said exhaust gases;
a secondary resonator set between said inner resonator and an exit port;
a moveable plug to vary the available surface area for exiting said exhaust gases;
said moveable plug being actuated between closed and open configuration by way of a sliding rod sliding along an axis parallel to the length of said outer cylinder;
an annular passage created when said sliding rod slides to an open position said annular passage surrounding said moveable plug to increase surface area available for said exhaust gases.

2. A sound level adjustable muffler to vary the sound level at the exhaust as in claim 1 having the following method of use:
actuating said moveable plug into an open configuration opens an annular passage which increases exit surface area;
said moveable plug actuated by said sliding rod;
said moveable plug being in an open configuration increases total surface area available at said secondary resonator which increases sound level accordingly;
actuating said moveable plug into a closed configuration closes an annular passage which decreases exit surface area making the total surface area available at the secondary resonator equal to the available surface area at the entrance port and thus reducing sound level.

3. A sound level adjustable muffler to vary the sound level at the exhaust as in claim 1 wherein:
said sliding rod being activated by an actuation means.

4. A sound level adjustable muffler to vary the sound level at the exhaust as in claim 3 wherein:
said sliding rod activation means being selected from the group comprising but not limited to direct connection to an actuating motor;
indirect connection by way of a cable adjusted by a control lever near handlebars;
an electric motor having an electrical control near said handlebars.

5. A sound level adjustable muffler to vary the sound level at the exhaust as in claim 4 wherein:
an attachment means is provided to attach said actuation means.

6. A sound level adjustable muffler to vary the sound level at the exhaust as in claim 1 wherein:
a cylindrical seal seals an area between the outside of said inner resonator and the inside of said moveable plug.

7. A sound level adjustable muffler to vary the sound level at the exhaust as in claim 1 wherein:
supporting segments support said inner resonator within the center of said outer cylinder.

8. A sound level adjustable muffler to vary the sound level at the exhaust as in claim 1 wherein:
a secondary resonator support segment to support said secondary resonator within said outer cylinder.

9. A sound level adjustable muffler to vary the sound level at the exhaust as in claim 1 wherein:
said secondary resonator has a horn like ending.
